(19) United States
(12) Patent Application Publication
(10) Pub. No.: US 2024/0351112 A1
(43) Pub. Date: Oct. 24, 2024

(54) TOOL HOLDER AND TURRET

(71) Applicant: NT TOOL CORPORATION, Takahama-City, Aichi (JP)

(72) Inventors: Hitoshi ISHIKAWA, Takahama-City, Aichi (JP); Hiroyuki SUZUKI, Kariya-shi (JP)

(21) Appl. No.: 18/683,566

(22) PCT Filed: Mar. 8, 2022
(86) PCT No.: PCT/JP2022/010078

§ 371 Date: Feb. 14, 2024

(30) Foreign Application Priority Data
Aug. 26, 2021 (JP) 2021-137917

(51) Int. Cl. B23B 27/10; B23B 13/02

(52) U.S. Cl. CPC B23B 27/10; B23B 13/02

(57) ABSTRACT

A tool holder (100) holds a tool (170) in a non-rotatable manner. When an attaching surface (112a) of a body part (110, 120, 150) of the tool holder is attached to a tool holder attachment surface of a machine tool, cooling medium supplied from the machine tool flows through a first body part passage (114, 124). Then, a rotary member (130) is rotationally driven by a drive mechanism provided in the machine tool. When a rotary part of a pump (200) rotates with the rotary member, the pressure of the cooling medium suctioned into the pump is proportionally increased in accordance with the rotational speed of the rotary part, and pressurized cooling medium is discharged from an outlet part (202) of the pump. The pressurized cooling medium then flows through a second body part passage (115, 125) and is thereafter sprayed from a spray hole (161) of a nozzle (160).

### CROSS-REFERENCE

This application is the US national stage of International patent application no. PCT/JP2022/010078 filed on Mar. 8, 2022, which claims priority to Japanese patent application no. 2021-137917 filed on Aug. 26, 2021.

### TECHNICAL FIELD

The present disclosure relates to a tool holder that holds a tool and to a turret to which multiple tool holders are detachably attachable.

### BACKGROUND ART

In machine tools that perform cutting processing (machining) and the like on metal workpieces, tool holders are used, which hold tools that process the workpieces.

Rotary tool holders (sometimes called “milling tool holders”) or non-rotating tool holders (sometimes called “turning tool holders”) are used as the tool holders. Rotary tool holders hold tools (sometimes called “milling tools” or “rotary tools”), which process (machine) a fixed workpiece, in a rotatable manner. Non-rotating tool holders hold tools (sometimes called “turning tools” or “non-rotating tools”), which process (machine) rotating workpieces, in a non-rotatable manner.

Here, in order to be able to perform multiple processing operations continuously, a machine tool equipped with a turret is used. The turret is configured to be rotatable around a turret centerline. Furthermore, multiple tool holder attachment surfaces are provided, in the circumferential direction, on the outer peripheral sides of the turret, to which attaching surfaces of tool holders holding tools are respectively attachable. Then, the turret is rotated by a turret drive mechanism so that a tool holder holding a tool used for processing (a tool holder attachment surface to which an attaching surface of a tool holder is attached) is disposed in a processing position. A rotary tool holder and a non-rotating tool holder can be attached to the tool holder attachment surfaces. Such a turret is disclosed, for example, in Patent Document 1 (Japanese Unexamined Patent Application Publication No. 2006-167862 A).

When processing a workpiece using a tool, it is necessary to supply a cooling medium such as an oil (called a “coolant”) to the cutting edge of the tool for lubrication between the workpiece and the tool, for cooling the workpiece or the tool, for removing chips (sometimes called “swarf” or “tendrils”) generated by the processing, and the like.

For this purpose, a tool holder is used, which is provided with a cooling medium supply mechanism that conducts cooling medium supplied from the machine tool. The cooling medium is then sprayed onto the cutting edge of the tool or the like.

Furthermore, tool holders have been proposed that are provided with a cooling medium supply mechanism having a pump, in order to increase the pressure of the cooling medium. Such a tool holder is disclosed, for example, in Patent Document 2 (Japanese Unexamined Patent Application Publication No. S62-4550 A).

### PRIOR ART PATENT DOCUMENTS

Patent Document 1: Japanese Unexamined Patent Application Publication No. 2006-167862 A
Patent Document 2:Japanese Unexamined Patent Application Publication No. S62-4550 A

### SUMMARY

At the pressure of the cooling medium supplied from ordinary machine tools, sufficient cooling effects and lubricating effects may not be obtained by the cooling medium that is sprayed from the cooling medium supply mechanism provided in the tool holder. Furthermore, it may not be possible to sufficiently remove chips generated during the processing. In such a case, after processing the workpiece an operator needs to perform the operation of removing chips remaining on the workpiece (removal operation).

Here, it would be conceivable to enhance the chip removal effect by increasing the pressure of the cooling medium sprayed from the cooling medium supply mechanism that is provided in the tool holder.

In order to increase the pressure of the cooling medium sprayed from the cooling medium supply mechanism that is provided in the tool holder, it would be necessary to increase the pressure of the cooling medium supplied from the machine tool.

However, in order to increase the pressure of the cooling medium supplied from the machine tool, it would be necessary to design the machine tool to high pressure specifications, which is very expensive.

Furthermore, it might be conceivable to use a tool holder provided with a cooling medium supply mechanism constituted by a pump having a rotary part that is rotationally driven by a drive mechanism provided in the machine tool, as disclosed in Patent Document 2. In this case, the pressure of the cooling medium sprayed from the cooling medium supply mechanism could be increased by increasing the rotational speed of the rotary part of the pump.

However, the tool holder disclosed in Patent Document 2 sprays cooling medium onto the cutting edge of the tool or the like while simultaneously rotating the tool that it holds so as to process (machine) the workpiece. There is, therefore, a limit on increasing the rotational speed of the tool holder.

Furthermore, since non-rotating tool holders that hold tools in a non-rotatable manner do not have a rotary part, the pressure of the cooling medium cannot be increased in non-rotating tool holders by using the pump disclosed in Patent Document 2.

In particular, when using a non-rotating tool holder that holds a tool in a non-rotatable manner, long continuous chips (tendrils) tend to be generated when processing. If such long continuous chips wrap around the tool or the workpiece, the tool or the workpiece may be damaged.

Therefore, there is a demand for the development of techniques for non-rotating tool holders that hold tools in a non-rotatable manner, which can prevent long continuous chips from wrapping around the tool or the workpiece.

Accordingly, it is one non-limiting object of the present disclosure to provide techniques for tool holders that hold tools in a non-rotatable manner (non-rotating tool holders) such that high-pressure cooling medium can be sprayed in a focused manner toward a predetermined location, chips generated when processing can be fragmented thereby, and thus long continuous chips can be prevented from wrapping around the tool or the workpiece.

In a first aspect of the present disclosure, a tool holder holds a tool, which processes a rotating workpiece, in a non-rotatable manner (non-rotating tool holder).

The tool holder of the present disclosure includes a body part, a rotary member, a pump, and a nozzle.

The body part has an attaching part that can be detachably attached to a tool holder attachment part of a machine tool. For example, a tool holder attachment surface provided at the outer periphery of a turret on the machine tool is used as the tool holder attachment part.

Furthermore, the body part has a body part inner peripheral surface, a body part interior space formed (defined) by the body part inner peripheral surface, a first body part passage, and a second body part passage.

The rotary member is rotatably disposed within the body part interior space. Various methods can be used to dispose the rotary member in a rotatable manner within the body part interior space.

The pump has a rotary part, an inlet part (inlet port), and an outlet part (outlet port). The rotary part of the pump is disposed in the body part interior space so as to be rotatable in conjunction with the rotation of the rotary member. The inlet part fluidly communicates with the first body part passage of the body part and the outlet part fluidly communicates with the second body part passage of the body part. Furthermore, the pump is configured to increase the pressure of the cooling medium suctioned from the inlet part to a pressure corresponding to the rotational speed of the rotary part, and to discharge pressurized cooling medium from the outlet part.

A variety of configurations of known pumps, which have rotary parts, can be used as the pump. Various methods can be used to rotate the rotary part of the pump in conjunction with the rotation of the rotary member.

The nozzle has a spray hole that sprays the cooling medium. Furthermore, the nozzle is attached to the body part so that the spray hole fluidly communicates with the second body part passage of the body part.

Furthermore, the tool holder is configured so that, in a state in which the attaching part has been attached to the tool holder attachment part, cooling medium supplied from the machine tool is conducted through the first body part passage. In addition, the rotary member is configured so as to be rotationally driven by a drive mechanism provided in the machine tool.

The rotational speed of the rotary part (rotary member) of the pump is set so that the pressure of the cooling medium sprayed from the spray hole will be a predetermined pressure that can fragment chips generated by processing (machining) the workpiece.

Thus, the tool holder of the first aspect is configured such that a high-pressure cooling medium can be sprayed in a focused manner toward a predetermined location while the tool holder holds a tool in a non-rotatable manner (non-rotating tool holder). It is thereby possible to fragment chips generated when processing a workpiece, and it is possible to prevent long continuous chips (tendrils) from wrapping around the tool or the workpiece.

In another aspect of the present disclosure, the body part is constituted by a body member, a sleeve, and a cap.

The body member is formed in a cylindrical shape, and includes an attaching part, a body member inner peripheral surface, a body member interior space formed by the body member inner peripheral surface, a first body member passage and a second body member passage, which open at the body member inner peripheral surface.

The sleeve is formed in a cylindrical shape and includes a sleeve inner peripheral surface, a sleeve outer peripheral surface, a sleeve interior space formed by the sleeve inner peripheral surface, a first sleeve passage and a second sleeve passage, which open at the sleeve outer peripheral surface and at the sleeve inner peripheral surface.

The sleeve is disposed within the body member interior space so that the first sleeve passage fluidly communicates with the first body member passage and the second sleeve passage fluidly communicates with the second body member passage.

The cap is provided on the sleeve so as to close the front end side of the sleeve interior space.

The rotary member is rotatably disposed within the body member interior space.

The pump is configured so that the rotary part is disposed between the rotary member and the cap, the inlet part fluidly communicates with the first sleeve passage, and the outlet part fluidly communicates with the second sleeve passage.

The nozzle is attached to the body member so that the spray hole fluidly communicates with the second body member passage.

Furthermore, the tool holder is configured such that, in the state in which the attaching part has been attached to the tool holder attachment part, cooling medium supplied from the machine tool is conducted through the first body member passage.

According to this aspect of the present disclosure, the tool holder can be configured easily.

Another aspect of the present disclosure relates to a turret.

The turret is provided on a machine tool and is rotatable around a turret centerline. The turret is provided with a plurality of tool holder attachment parts in the circumferential direction on the outer peripheral side, to which attaching parts of tool holders are detachably attachable.

Furthermore, a turret drive mechanism is provided. The turret drive mechanism rotates the turret around the turret centerline so that one of the plurality of tool holder attachment parts (a tool holder attached to a tool holder attachment part) is disposed at a predetermined processing position.

Furthermore, a cooling medium supply mechanism is provided in the machine tool. The cooling medium supply mechanism is configured such that the cooling medium is suppliable to a tool holder attached to a tool holder attachment part which is disposed at a processing position.

Furthermore, a drive mechanism is in the machine tool. The drive mechanism is configured to rotatably drive the rotary part of the tool holder attached to the tool holder attachment part disposed at the processing position.

Furthermore, a tool holder that has a pump and that holds a tool in a non-rotatable manner (non-rotating tool holder), which is described above, is attached to at least one of the plurality of tool holder attachment parts.

The drive mechanism rotationally drives the rotary member when, for example, a tool holder that has a pump and that holds a tool in a non-rotatable manner (non-rotating tool holder) is attached to a tool holder attachment part. Furthermore, the drive mechanism rotationally drives a rotary shaft that rotates a tool when a tool holder that holds the tool (rotary tool holder) in a rotatable manner is attached to a tool holder attachment part.

Such a turret has the same effect as the above-mentioned tool holder when using a tool holder that holds a tool in a non-rotatable manner (non-rotating holder) attached to the tool holder attachment part.

By using a tool holder of the present disclosure (and optionally also a turret of the present disclosure) when processing (machining) a workpiece using a tool that is held in the tool holder in a non-rotatable manner, a high-pressure cooling medium can be sprayed in a focused manner toward a predetermined location. Chips generated when processing can thereby be fragmented, thereby preventing long continuous chips (tendrils) from wrapping around the tool or the workpiece.

### BRIEF DESCRIPTION OF THE DRAWINGS

FIG. 1 shows a representative embodiment of a turret of the present disclosure.

FIG. 2 is a cross-sectional view of a representative embodiment of a tool holder of the present disclosure.

FIG. 3 is an enlarged view, in which a key portion of FIG. 2 has been enlarged.

### DETAILED DESCRIPTION

The following detailed description merely teaches those skilled in the art detailed information for practicing preferred embodiments of the present disclosure. The technical scope of the present invention is not limited by the detailed description, but rather is defined based on the description in the claims. Therefore, not all combinations of structures and methods in the following detailed description are essential for carrying out the present invention in the broad sense, and the detailed description set forth together with the reference numerals in the accompanying drawings merely discloses representative modes of the present invention.

A representative embodiment of the tool holder of the present disclosure will be described below with reference to the drawings.

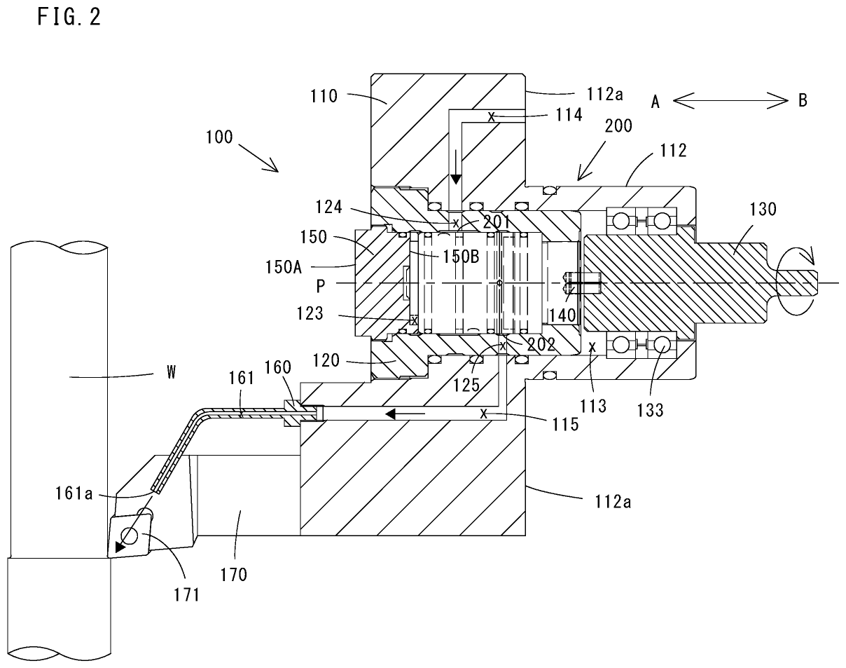

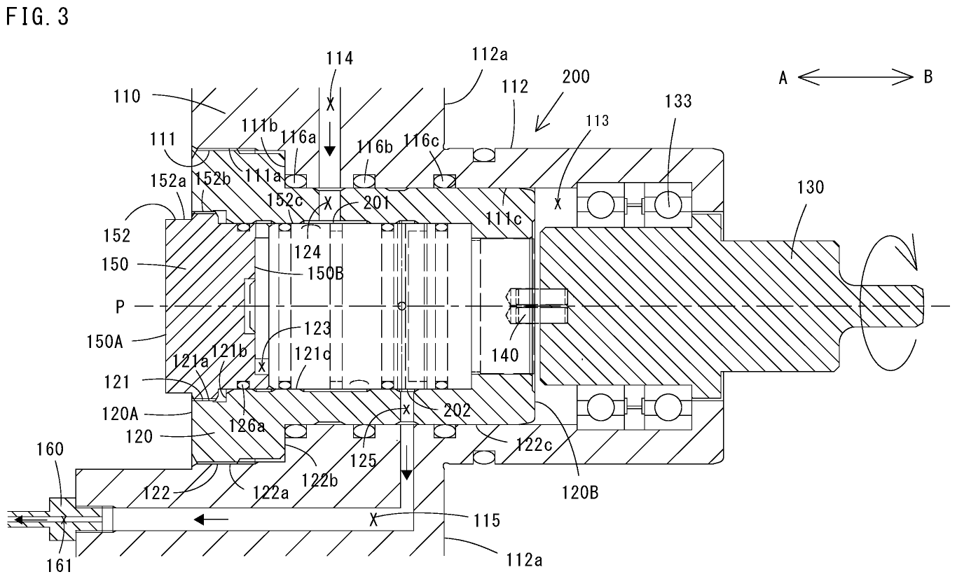

Note that, hereinafter, the direction along the centerline P of the tool holder 100 (the rotation centerline of the rotary member 130 and the rotary part of the pump 200) will be referred to as the “axial direction”. Furthermore, in the axial direction, the side opposite to the side where the rotary member 130 is disposed (the side which arrow A points in FIG. 2 and FIG. 3) is referred to as the “front end side” or “one side in the axial direction”. Furthermore, in the axial direction, the side where the rotary member 130 is disposed (the side which arrow B points in FIG. 2 and FIG. 3) is referred to as the “rear end side” or “the other side in the axial direction”.

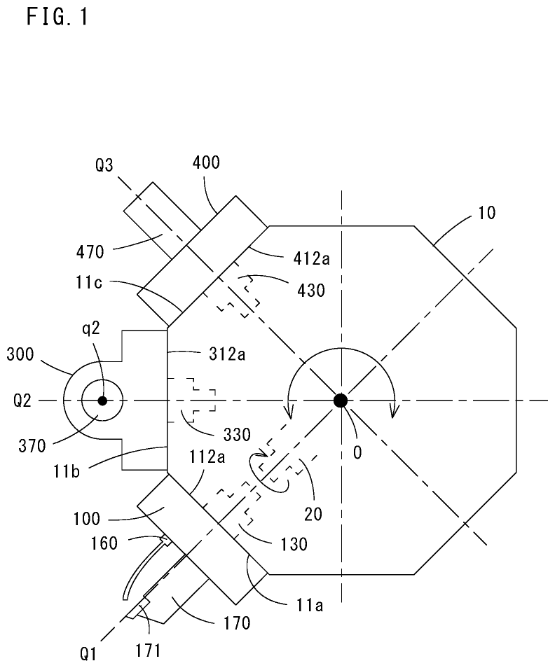

First, a representative embodiment of the turret 10 of the present disclosure will be described with reference to FIG. 1.

The turret 10 is provided on a machine tool and is rotatable around the turret centerline O.

Multiple tool holder attachment surfaces 11a to 11c are provided in the circumferential direction on the outer peripheral side of the turret. In the present embodiment, the tool holder attachment surfaces 11a to 11c are provided at equal intervals. Note that, in FIG. 1, in order to facilitate description, only three of the tool holder attachment surfaces 11a to 11c are labeled with reference numerals.

The attaching surfaces of the tool holders can be detachably attached to the tool holder attachment surfaces 11a to 11c. In the present embodiment, the tool holder attachment surfaces 11a to 11c extend in directions that intersect (preferably perpendicularly intersect) with directions of extension of attachment surface centerlines Q1 to Q3, which extend at equal intervals around the turret centerline O.

In FIG. 1, an attaching surface 112a of the tool holder 100 is detachably attached to the tool holder attachment surface 11a. The tool holder 100 holds a tool 170 having a cutting edge 171 in a non-rotatable manner. Hereinafter, the tool holder 100 will be referred to as a “non-rotating tool holder 100” and the tool 170 will be referred to as a “non-rotating tool 170”. Note that a tool that is held in a non-rotatable manner is sometimes called a “turning tool.”

An attaching surface 312a of a tool holder 300 is attached to the tool holder attachment surface 11b. The tool holder 300 holds a tool 370 so as to be rotatable around a tool rotation centerline q2 that intersects (preferably perpendicularly intersects) with the direction of extension of the attachment surface centerline Q2. Hereinafter, the tool holder 300 will be referred to as a “rotary tool holder 300” and the tool 370 will be referred to as a “rotary tool 370”. Note that a tool held in a rotatable manner is sometimes called a “milling tool”.

An attaching surface 412a of a tool holder 400 is attached to the tool holder attachment surface 11c. The tool holder 400 holds a tool 470 so as to be rotatable around the attachment surface centerline Q3. Hereinafter, the tool holder 400 will be referred to as “rotary tool holder 400” and the tool 470 will be referred to as “rotary tool 470”.

The turret 10 is rotationally driven around the turret centerline O by a turret drive mechanism (not illustrated) so that any one of the tool holder attachment surfaces 11a to 11c (i.e. the tool holders 100, 300, and 400 attached to the tool holder attachment surfaces 11a to 11c) is disposed in a predetermined processing (machining) position.

In the present embodiment, the tool holder 100 corresponds to a “tool holder that holds a tool in a non-rotatable manner” of the present disclosure.

Furthermore, the tool holder attachment surfaces 11a to 11c correspond to a “tool holder attachment part” of the present disclosure. Furthermore, the attaching surfaces 112a, 312a, and 412a correspond to an “attaching part” of the present disclosure.

Furthermore, a drive mechanism 20 is provided that rotationally drives a rotary part of a tool holder attached to a tool holder attachment surface disposed at a processing (machining) position. For example, a drive mechanism constituted by a drive means such as a motor can be used as the drive mechanism 20.

In the example shown in FIG. 1, the non-rotating tool holder 100 having a pump of the present disclosure is attached to the tool holder attachment surface 11a disposed at the processing position and includes a rotary member 130 (described hereafter). Note that conventional non-rotating tool holders do not have such a rotary member because they hold a non-rotating tool in a non-rotatable manner and do not have a pump that pressurizes a cooling medium.

Furthermore, the rotary tool holder 300 attached to the tool holder attachment surface 11b includes a rotary shaft 330. The rotary tool 370 is configured to be rotated by the rotary shaft 330.

Further, the rotary tool holder 400 attached to the tool holder attachment surface 11c includes a rotary shaft 430. The rotary tool 470 is configured to be rotated by the rotary shaft 430.

Furthermore, a cooling medium supply mechanism (not illustrated) is provided, which supplies a cooling medium to a tool holder attached to a tool holder attachment surface disposed at a processing position.

In the non-rotating tool holder 100 shown in FIG. 1, the cooling medium supplied from the cooling medium supply mechanism is pressurized by the pump 200 (described hereafter) and then sprayed from the spray hole 161 of the non-rotating nozzle 160.

In the rotary tool holders 300 and 400, the cooling medium supplied from the cooling medium supply mechanism is sprayed directly from spray holes that rotate together with the tool.

Note that the rotary tool holders 300 and 400 can also be configured so that the cooling medium supplied from the cooling medium supply mechanism is pressurized by a pump, and then sprayed from spray holes that rotate together with the tool, as disclosed in Patent Document 2.

Next, a representative embodiment of the non-rotating tool holder 100 will be described with reference to FIG. 2 and FIG. 3.

FIG. 2 is a cross-sectional view of the representative embodiment of a non-rotating tool holder 100. Furthermore, FIG. 3 is an enlarged view, in which a key portion of FIG. 2 has been enlarged.

The non-rotating tool holder 100 in the present embodiment includes a body part, a rotary member 130, a pump 200, and a nozzle 160.

The non-rotating tool holder 100 includes a tool holding mechanism (not illustrated) that holds the non-rotating tool 170 in a non-rotatable manner. A variety of configurations of known tool holding mechanisms can be used as the tool holding mechanism that holds the non-rotating tool 170.

The body part is constituted by a body member 110, a sleeve 120, and a cap 150.

The body member 110 is formed in a cylindrical shape and has a body member inner peripheral surface 111 and a body member outer peripheral surface 112. A body member interior space 113 is formed (defined) by the body member inner peripheral surface 111.

In the present embodiment, the body member inner peripheral surface 111 has body member inner peripheral surface portions 111a to 111c. The body member inner peripheral surface portions 111a and 111c have a circular cross section and extend in the axial direction. The body member inner peripheral surface portion 111c is disposed further to the rear end side than the body member inner peripheral surface portion 111a and has an inner diameter smaller than the inner diameter of the body member inner peripheral surface portion 111a. The body member inner peripheral surface portion 111b extends in the radial direction and forms (defines) a step surface connecting the body member inner peripheral surface portions 111a and 111c. A female thread is formed on the body member inner peripheral surface portion 111a.

The body member outer peripheral surface 112 has a body member outer peripheral surface portion 112a. The body member outer peripheral surface portion 112a extends in the radial direction. The body member outer peripheral surface portion 112a is configured to be detachably attachable to the tool holder attachment surfaces 11a to 11c of the turret 10.

The body member outer peripheral surface portion 112a corresponds to a “body part outer peripheral surface portion” or an “attaching part” of the present disclosure.

Furthermore, a first body member passage 114 and a second body member passage 115 are formed (defined) in the body member 110.

The first body member passage 114 opens at the body member outer peripheral surface portion 112a and the body member inner peripheral surface (body member inner peripheral surface portion 111c). Furthermore, the second body member passage 115 opens at the body member inner peripheral surface (body member inner peripheral surface portion 111c).

Furthermore, the tool holder 100 is configured such that, in the state in which the body member outer peripheral surface portion 112a has been attached to a tool holder attachment surface 11a to 11c, the cooling medium supplied from the machine tool is conducted through the first body member passage 114.

Note that the nozzle 160 can be attached to the body member 110 so that a spray hole 161 of the nozzle 160 fluidly communicates with the second body member passage 115.

The sleeve 120 is formed in a cylindrical shape and has a sleeve inner peripheral surface 121, a sleeve outer peripheral surface 122, a sleeve front end surface 120A, and a sleeve rear end surface 120B. A sleeve interior space 123 is formed (defined) by the sleeve inner peripheral surface 121.

In the present embodiment, the sleeve inner peripheral surface 121 has sleeve inner peripheral surface portions 121a to 121c. The sleeve inner peripheral surface portions 121a and 121c have a circular cross section and extend in the axial direction. The sleeve inner peripheral surface portion 121c is disposed further to the rear end side than the sleeve inner peripheral surface portion 121a, and has an inner diameter smaller than the inner diameter of the sleeve inner peripheral surface portion 121a. The sleeve inner peripheral surface portion 121b extends in the radial direction and forms a step surface connecting the sleeve inner peripheral surface portions 121a and 121c. A female thread is formed in the sleeve inner peripheral surface portion 121a.

The sleeve outer peripheral surface 122 has sleeve outer peripheral surface portions 122a to 122c. The sleeve outer peripheral surface portions 122a and 122c have a circular cross section and extend in the axial direction. The sleeve outer peripheral surface portion 122c is disposed further to the rear end side than the sleeve outer peripheral surface portion 122a, and has an outer diameter smaller than the outer diameter of the sleeve outer peripheral surface portion 122a. The sleeve outer peripheral surface portion 122b extends in the radial direction and forms a step surface connecting the sleeve outer peripheral surface portions 122a and 122c. A male thread is formed on the sleeve outer peripheral surface portion 122a, which can be screw fastened with the female thread formed on the body member inner peripheral surface portion 111a.

The sleeve 120 is fixed to the body member 110 in the state in which it has been inserted into the body member interior space 113. In the present embodiment, the sleeve 120 is fixed to the body member 110 by inserting the sleeve 120 to a position at which the sleeve outer peripheral surface portion 122b abuts the body member inner peripheral surface portion 111b, in the state in which the male thread formed on the sleeve outer peripheral surface portion 122a has been screw fastened with the female thread formed on the body member inner peripheral surface portion 111a.

The method for fixing the sleeve 120 to the body member 110 is not limited to this, and a variety of known methods can be used.

In the present embodiment, a space, in which a rotary member 130 (described hereafter) is disposed, is formed (defined) within the body member interior space 113, further to the rear end side than the sleeve rear end surface 120B.

Note that sealing members 116a to 116c such as O-rings are disposed between the body member 110 and the sleeve 120.

Furthermore, the sleeve 120 has a first sleeve passage 124 and a second sleeve passage 125.

The tool holder 100 is configured such that, in the state in which the sleeve 120 is fixed to the body member 110, the first sleeve passage 124 fluidly communicates with the first body member passage 114 and with an inlet part (inlet port) 201 of the pump 200.

Similarly, the tool holder 100 is configured such that, in the state in which the sleeve 120 is fixed to the body member 110, the second sleeve passage 125 fluidly communicates with the second body member passage 115 and with an outlet part (outlet port) 202 of the pump 200.

Note that, in the present embodiment, the inlet part 201 and the outlet part 202 of the pump 200 (the first sleeve passage 124 communicating with the inlet part 201 and the second sleeve passage 125 communicating with the outlet part 202) are disposed at positions that are spaced apart in the axial direction.

The cap 150 has a cap outer peripheral surface 152, a cap front end surface 150A, and a cap rear end surface 150B.

The cap outer peripheral surface 152 has cap outer peripheral surface portions 152a to 152c. The cap outer peripheral surface portions 152a to 152c have a circular cross section and extend in the axial direction. The cap outer peripheral surface portion 152c is disposed further to the rear end side than the cap outer peripheral surface portion 152a. The cap outer peripheral surface portion 152b is disposed between the cap outer peripheral surface portions 152a and 152c, and has an outer diameter larger than the outer diameter of cap outer peripheral surface portions 152a and 152c. A male thread that is screw fastenable with the female thread formed on the sleeve inner peripheral surface portion 121a is formed (defined) on the cap outer peripheral surface portion 152b.

The cap 150 is fixed on the front end side of the sleeve 120. In the present embodiment, the cap 150 is fixed to the sleeve 120 by screw fastening the male thread formed on the cap outer peripheral surface portion 152b with the female thread formed on the sleeve inner peripheral surface portion 121a.

Note that a sealing member 126a such as an O-ring is disposed between the sleeve 120 and the cap 150.

The method for fixing the cap 150 to the sleeve 120 is not limited to this, and a variety of known methods can be used.

The rotary member 130 is rotatably disposed within the body member interior space 113. In the present embodiment, the rotary member 130 is rotatably disposed in the rear end part of the body member interior space 113 (further to the rear end side than the sleeve rear end surface 120B) with a bearing 133 therebetween. The rotary member 130 is thereby rotatable relative to the body member 110.

Note that the tool holder 100 is configured such that, in the state in which the body member outer peripheral surface portion 112a of the tool holder 100 has been attached to the tool holder attachment surface 11a, the rotary member 130 is rotationally driven by the drive mechanism 20 provided in the machine tool. Specifically, in the state in which the tool holder attachment surface 11a has been disposed at the processing position, the rotary member 130 of the tool holder 100, which is attached to the tool holder attachment surface 11a, is rotationally driven by the drive mechanism 20.

The pump 200 is disposed between the cap 150 and the rotary member 130.

The pump 200 has a rotary part rotatably disposed in the sleeve interior space 123. A variety of known pumps, which have rotary parts, can be used as the pump 200. In the present embodiment, an internal gear pump is used.

One end side of the rotary part of the pump 200 is connected to the rotary member 130. In the present embodiment, the rear end part of the rotary part of the pump 200 is connected to the rotary member 130 via knock pins 140. Furthermore, the other end side of the rotary part of the pump 200 is rotatably supported in the cap 150. In the present embodiment, the front end part of the rotary part of the pump 200 is rotatably supported within a recessed part formed in the cap rear end surface 150B of the cap 150.

The rotary part of the pump 200 is thereby rotatable in conjunction with the rotation of the rotary member 130.

As was mentioned above, the pump 200 has the inlet part (port) 201 and the outlet part (port) 202. The inlet part 201 fluidly communicates with the first body member passage 114 via the first sleeve passage 124. Furthermore, the outlet part 202 fluidly communicates with the second body member passage 115 via the second sleeve passage 125.

The pump 200 increases the pressure of the cooling medium suctioned from the inlet part 201 to a pressure corresponding to the rotational speed of the rotary part, and discharges the pressurized cooling medium from the outlet part 202.

In the present embodiment, a “body part” of the present disclosure is constituted by the body member 110, the sleeve 120, and the cap 150.

Furthermore, the body member outer peripheral surface 112 constitutes a “body part outer peripheral surface” of the present disclosure. Furthermore, the body member inner peripheral surface 111 and the sleeve inner peripheral surface 121 constitute a “body part inner peripheral surface” of the present disclosure. Furthermore, the body member interior space 113 and the sleeve interior space 123 constitute a “body part interior space” of the present disclosure.

Furthermore, the first body member passage 114 and the first sleeve passage 124 constitute a “first body part passage” of the present disclosure. Similarly, the second body member passage 115 and the second sleeve passage 125 constitute a “second body part passage” of the present disclosure.

Furthermore, a “pump” of the present disclosure is constituted by the sleeve 120, the rotary part, the inlet part 201, and the outlet part 202.

The nozzle 160 has a spray hole 161 that is open at both ends. The nozzle 160 can be attached to the body member 110 so that an opening on one side of spray hole 161 fluidly communicates with the second body member passage 115. In the present embodiment, the nozzle 160 is attached to the body member 110 by screw fastening a male thread formed (defined) on the outer periphery of the rear end side of the nozzle 160 and a female thread formed (defined) on the inner peripheral surface of the second body member passage 115.

The cooling medium sprayed from the opening 161a of the spray hole 161 of the nozzle 160 is thereby not affected by rotation of the opening 161a of the spray hole 161. Consequently, the cooling medium can be sprayed in a focused manner toward a predetermined location.

The shape of the nozzle 160 is set (designed) so that the cooling medium sprayed from the opening 161a on the other side of the spray hole 161 (i.e. the opening on the opposite side to the opening that is in fluid communication with the second body member passage 115) is sprayed onto the processed part of the workpiece W.

Note that the rotational speed of the rotary part of the pump 200 (rotary member 130) is set to a predetermined rotational speed at which the pressure of the cooling medium sprayed from the opening 161a of the spray hole 161 in the nozzle 160 reaches a pressure that can fragment chips (e.g., tendrils) generated when processing (machining) the workpiece W.

By fragmenting the chips generated when processing, it is possible to prevent long continuous chips (tendrils) from wrapping around the tool 170 or the workpiece W.

One example of an operation when processing a workpiece W using the non-rotating tool 170 will be described below.

The workpiece W is attached to the machine tool.

From among the tool holders, a non-rotating tool holder 100 holding a non-rotating tool 170 that is required for processing (machining) is attached to the tool holder attachment surface 11a of the turret 10.

The turret 10 is rotated so that the tool holder attachment surface 11a is disposed at a processing (machining) position.

By controlling the rotational speed and position of the workpiece W, the workpiece W is processed using the non-rotating tool 170 that is held in the non-rotating tool holder 100.

At this time, the rotary member 130 that is connected to the rotary part of the pump 200 is set to a predetermined rotational speed. Cooling medium having a pressure capable of fragmenting chips generated by processing is thereby sprayed from the opening 161a of the spray hole 161 in the nozzle 160 onto the processed part of the workpiece W (i.e. the portion being processed (machined, cut) by the cutting edge 171 of the non-rotating tool 170).

As described above, by using the non-rotating tool holder 100 of the present embodiment when processing the workpiece W with the non-rotating tool 170, high-pressure cooling medium can be sprayed onto the processed part in a focused manner from the opening 161a of the spray hole 161 in the nozzle 160. Long continuous chips (tendrils) can thereby be prevented from wrapping around the non-rotating tool 170 and the workpiece W, and damage to the non-rotating tool 170 and the workpiece W can be prevented.

Furthermore, because the drive mechanism that rotationally drives the rotary shaft of the rotary tool holder is used as the drive source that rotates the rotary part of the pump 200, there is no need to provide a separate (additional) drive source.

The present invention is not limited to the configuration described in the embodiment described above, and various modifications, additions, and eliminations thereto are possible.

A variety of configurations of tool holding mechanisms can be used as the tool holding mechanism that holds the non-rotating tool in the non-rotating tool holder.

Various methods can be used to detachably attach the body part of the non-rotating tool holder to the machine tool.

Various methods can be used to design the tool holder such that the cooling medium supplied from the machine tool is conducted through the first body part passage.

A variety of configurations of known pumps, which have a rotary part, an inlet part, and an outlet part, can be used as the pump.

Various methods can be used to design the tool holder such that the rotary member is disposed in a rotatable manner within the body part interior space.

Various methods can be used to connect the rotary member and the rotary part of the pump.

The shapes and configurations of the body member, sleeve, cap, and rotary member are not limited to the shapes and configurations described in the embodiment above, and can be modified in various ways.

A variety of configurations of nozzles can be used as the nozzle.

In the embodiment above, the body part is constituted by a body member, a sleeve, and a cap, but it is not limited to this. For example, the body part can also be constituted as a single member, in which a body member, a sleeve, and a cap are integrated. Further, the body part can be constituted by (as) a member, in which a body member and a sleeve are integrated, and a cap, or alternatively, the body part can be constituted by (as) a member, in which a sleeve and a cap are integrated, and a body member.

The configurations described in the embodiment above can be used alone or an appropriately selected plurality thereof can be used in combinations.

### EXPLANATION OF THE REFERENCE NUMERALS

10 turret
11a to 11c tool holder attachment surface (tool holder attachment part)
20 drive mechanism
100 tool holder (non-rotating tool holder)
110 body member
111 body member inner peripheral surface
111a to 111c body member inner peripheral surface portion
112 body member outer peripheral surface
112a body member outer peripheral surface portion (attaching part)
113 body member interior space
114 first body member passage
115 second body member passage
116a to 116c O-ring (sealing member)
120 sleeve
120A sleeve front end surface
120B sleeve rear end surface
121 sleeve inner peripheral surface
121a to 121c sleeve inner peripheral surface portion
122 sleeve outer peripheral surface
122a to 122c sleeve outer peripheral surface portion
123 sleeve interior space
124 first sleeve passage
125 second sleeve passage
126a O-ring (sealing member)
130 rotary member
133 bearing
140 anti-rotation pin
150 cap
150A cap front end surface
150B cap rear end surface
152 cap outer peripheral surface
152a to 152c cap outer peripheral surface portion
160 nozzle
161 spray hole
161a opening
170 tool (non-rotating tool)
171 cutting edge
200 pump
201 inlet part
202 outlet part
300, 400 tool holder (rotary tool holder)
312a, 412a attaching surface
330, 430 rotary shaft
370, 470 tool (rotary tool)
W workpiece

1. A tool holder configured to hold a tool for processing a workpiece in a non-rotatable manner, comprising:
a body part, a rotary member, a pump, and a nozzle,
wherein:
the body part has an attaching part configured to be detachably attached to a tool holder attachment part of a machine tool, a body part inner peripheral surface, a body part interior space formed by the body part inner peripheral surface, a first body part passage, and a second body part passage;
the rotary member is rotatably disposed within the body part interior space of the body part;
the pump has a rotary part, an inlet part, and an outlet part, and is configured so that the rotary part is disposed in the body part interior space of the body part so as to be rotatable in conjunction with rotation of the rotary member, the inlet part communicates with the first body part passage of the body part, the outlet part communicates with the second body part passage of the body part, and the pressure of cooling medium suctioned from the inlet part is increased to a pressure corresponding to the rotational speed of the rotary part and pressurized cooling medium is discharged from the outlet part;
the nozzle has a spray hole configured to spray the pressurized cooling medium, and is attached to the body part so that the spray hole communicates with the second body part passage of the body part; and
the tool holder is configured such that, in a state in which the attaching part has been attached to the tool holder attachment part, cooling medium supplied from the machine tool is conducted through the first body part passage, and the rotary member is rotationally drivable by a drive mechanism provided in the machine tool.

2. The tool holder according to claim 1, wherein:
the body part includes a body member, a sleeve, and a cap;
the body member is formed in a cylindrical shape, and has the attaching part, a body member inner peripheral surface, a body member interior space formed by the body member inner peripheral surface, a first body member passage that opens at the body member inner peripheral surface, and a second body member passage that opens at the body member inner peripheral surface;
the sleeve is formed in a cylindrical shape and has a sleeve inner peripheral surface, a sleeve outer peripheral surface, a sleeve interior space formed by the sleeve inner peripheral surface, a first sleeve passage that opens at the sleeve outer peripheral surface and the sleeve inner peripheral surface, and a second sleeve passage that opens at the sleeve inner peripheral surface and at the sleeve outer peripheral surface;
the sleeve is disposed in the body member interior space so that the first sleeve passage communicates with the first body member passage and the second sleeve passage communicates with the second body member passage;
the cap is provided on the sleeve so as to close the front end side of the sleeve interior space;
the rotary member is rotatably disposed in the body member interior space;
the pump is configured so that the rotary part is disposed between the rotary member and the cap, the inlet part communicates with the first sleeve passage, and the outlet part communicates with the second sleeve passage;
the nozzle is attached to the body member so that the spray hole communicates with the second body member passage; and
the tool holder is configured such that, in the state in which the attaching part has been attached to the tool holder attachment part, the cooling medium supplied from the machine tool is conducted through the first body member passage.

3. (canceled)

4. The tool holder according to claim 1, wherein:
the body part includes a body member having a cylindrical shape, and
the body member has the attaching part, a body member inner peripheral surface, a body member interior space formed by the body member inner peripheral surface, a first body member passage that opens at the body member inner peripheral surface, and a second body member passage that opens at the body member inner peripheral surface.

5. The tool holder according to claim 4, wherein:
the body part includes a sleeve having a cylindrical shape;
the sleeve has a sleeve inner peripheral surface, a sleeve outer peripheral surface, a sleeve interior space formed by the sleeve inner peripheral surface, a first sleeve passage that opens at the sleeve outer peripheral surface and at the sleeve inner peripheral surface, and a second sleeve passage that opens at the sleeve inner peripheral surface and at the sleeve outer peripheral surface; and
the sleeve is disposed in the body member interior space so that the first sleeve passage is in fluid communication with the first body member passage and the second sleeve passage is in fluid communication with the second body member passage.

6. The tool holder according to claim 5, wherein:
the body part includes a cap is provided on the sleeve so as to close a front end side of the sleeve interior space;
the rotary member is rotatably disposed in the body member interior space; and
the rotary part of the pump is disposed between the rotary member and the cap, the inlet part is in fluid communication with the first sleeve passage, and the outlet part is in fluid communication with the second sleeve passage.

7. The tool holder according to claim 6, wherein:
the nozzle is attached to the body member so that the spray hole is in fluid communication with the second body member passage; and
the tool holder is configured such that, in the state in which the attaching part has been attached to the tool holder attachment part, the cooling medium supplied from the machine tool flows through the first body member passage.

8. A tool holder configured to hold a tool for processing a workpiece in a non-rotatable manner, comprising:
a body part having:
an attaching part configured to be detachably attachable to a tool holder attachment part of a machine tool,
an inner peripheral surface,
an interior space defined by the inner peripheral surface,
a first fluid passage, and
second fluid passage;
a rotary member rotatably disposed within the interior space of the body part;
a pump including:
a rotary part disposed in the interior space of the body part and configured to be rotated by the rotary member,
an inlet port in fluid communication with the first fluid passage of the body part, and
an outlet port in fluid communication with the second fluid passage of the body part, the pump being configured to proportionally increase the pressure of cooling medium suctioned from the inlet port in accordance with the rotational speed of the rotary part and to discharge pressurized cooling medium from the outlet port to the second fluid passage of the body part; and
a nozzle attached to the body part such that a spray hole of the nozzle is in fluid communication with the second fluid passage of the body part;
wherein the tool holder is configured such that, in a state in which the attaching part has been attached to the tool holder attachment part and the rotary member is being rotationally driven by a drive mechanism provided in the machine tool, cooling medium supplied from the machine tool flows into the first fluid passage of the body part.

9. The tool holder according to claim 8, wherein:
the body part includes a body member having a cylindrical shape; and
the attaching part is defined on the body member.

10. The tool holder according to claim 9, wherein the body member has:
a body member inner peripheral surface,
a body member interior space defined by the body member inner peripheral surface,
a first body member fluid passage that opens at the body member inner peripheral surface, and
a second body member fluid passage that opens at the body member inner peripheral surface.

11. The tool holder according to claim 10, wherein:
the body member inner peripheral surface is a first portion of the inner peripheral surface of the body part,
the body member interior space is a first portion of the interior space of the body part,
the first body member fluid passage is a first portion of the first fluid passage of the body part, and
a second body member fluid passage is a second portion of the first fluid passage of the body part.

12. The tool holder according to claim 11, wherein:
the body part includes a sleeve having a cylindrical shape;
the sleeve has:
a sleeve inner peripheral surface,
a sleeve outer peripheral surface,
a sleeve interior space defined by the sleeve inner peripheral surface,
a first sleeve fluid passage that opens at the sleeve outer peripheral surface and at the sleeve inner peripheral surface, and
a second sleeve fluid passage that opens at the sleeve inner peripheral surface and at the sleeve outer peripheral surface; and
the sleeve is disposed in the body member interior space so that the first sleeve fluid passage is in fluid communication with the first body member passage and the second sleeve fluid passage is in fluid communication with the second body member passage.

13. The tool holder according to claim 12, wherein:
the sleeve inner peripheral surface is a second portion of the inner peripheral surface of the body part,
the sleeve interior space is a second portion of the interior space of the body part,
the first sleeve passage is a second portion of the first fluid passage of the body part, and
the second sleeve passage is a second portion of the second fluid passage of the body part.

14. The tool holder according to claim 13, wherein:
the body part includes a removable cap that closes a front end side of the sleeve interior space;
the rotary member is rotatably disposed in the body member interior space; and
the rotary part of the pump is disposed between the rotary member and the cap in a direction along a rotational axis of the rotary part, the inlet port of the pump is in fluid communication with the first sleeve fluid passage, and the outlet of the pump is in fluid communication with the second sleeve fluid passage.

15. The tool holder according to claim 14, wherein:
the nozzle is attached to the body member such that the spray hole is in fluid communication with the second body member fluid passage; and
the tool holder is configured such that, in the state in which the attaching part has been attached to the tool holder attachment part, the cooling medium supplied from the machine tool flows through the first body member fluid passage and the first sleeve fluid passage into the inlet port of the pump.
